(19) United States
(12) Patent Application Publication
(10) Pub. No.: US 2024/0221374 A1
(43) Pub. Date: Jul. 4, 2024

(54) APPARATUS AND METHOD FOR GENERATING TRAINING DATA

(71) Applicant: KOREA INSTITUTE OF SCIENCE AND TECHNOLOGY, Seoul (KR)

(72) Inventors: Suhyun KIM, Seoul (KR); Yu-Jin KIM, Seoul (KR); Dogyun PARK, Seoul (KR)

(73) Assignee: KOREA INSTITUTE OF SCIENCE AND TECHNOLOGY, Seoul (KR)

(21) Appl. No.: 18/321,248

(22) Filed: May 22, 2023

(30) Foreign Application Priority Data
Dec. 29, 2022 (KR) 10-2022-0188728

(51) Int. Cl. G06V 10/82; G06V 10/77

(52) U.S. Cl. CPC G06V 10/82; G06V 10/7715

(57) ABSTRACT

An apparatus and method for generating training data according to an embodiment is disclosed. The apparatus for generating training data according to an embodiment includes at least one processor and a memory to store instructions for executing the at least one processor, wherein upon being executed by the at least one processor, the instructions allow the at least one processor to output a first image for one sample vector from a first generator included in the apparatus, and generate a second image from a second generator included in the apparatus based on the first image and a feature map extracted from a convolution block for each stage of a lightweight target model for the first image.

### DESCRIPTION OF GOVERNMENT-FUNDED RESEARCH AND DEVELOPMENT

This research is conducted under the support of National Research Council of Science & Technology research operating expense support (R&D) (major project cost) [Project Name: High risk disaster medicine and industrial accident prevention technology development, Project Serial Number: 1711151313, Project ID Number: CRC-20-02-KIST], Ministry of Science and ICT.

This research is conducted under the support of development of proprietary technology in SW computing industry (R&D, information-oriented) [Project Name: Development of audio quality enhancement technology in remote multilateral video conferencing, Project Serial Number: 1711153052, Project ID Number: 2021-0-00456-002], Ministry of Science and ICT.

### CROSS-REFERENCE TO RELATED APPLICATION

This application claims priority to Korean Patent Application No. 10-2022-0188728, filed on Dec. 29, 2022, and all the benefits accruing therefrom under 35 U.S.C. § 119, the contents of which in its entirety are herein incorporated by reference.

### BACKGROUND

### 1. Field

The disclosed embodiments relate to an apparatus and method for generating training data. More particularly, the disclosed embodiments relate to technology for generating training data similar to original training data without access to the original training data.

### 2. Description of the Related Art

Lightweight deep learning is essential for deep learning in mobile, edge or cloud environment. Here, lightweight deep learning refers to technology that generates a compression model with a similar level of performance to the original model and a smaller amount of computational resources.

In lightweight deep learning, in an example, knowledge distillation reuses the same training data learned by the teacher network to transfer the knowledge of the pre-trained teacher to the compressed student network. In another example, pruning compresses a lightweight target model by pruning some of all neurons and re-training the remaining neurons. That is, lightweight deep learning needs to reuse the original training data.

However, the privacy issue in deep learning limits the re-access to training data. Despite the need for lightweight deep learning, the reuse of the original training data is challenging.

To solve this problem, a method for synthesizing training data by optimizing a high dimension raw input space is proposed. However, the optimization of the high dimension raw input space has an inconsistency problem with the original data distribution.

The reason is that the optimization of the high dimension raw input space ignores specific information of individual images of the original training data since the statistics of the image characteristics is averaged. Moreover, due to optimization without nonlinearity, it is difficult to optimize the high dimension raw input space. That is, the existing solution has low fidelity to the distribution of original training data and low diversity.

### SUMMARY

The disclosed embodiments are directed to generating data similar to training data.

An apparatus for generating training data according to an embodiment includes at least one processor and a memory to store instructions for executing the at least one processor, wherein upon being executed by the at least one processor, the instructions allow the at least one processor to output a first image for one sample vector from a first generator included in the apparatus, and generate a second image from a second generator included in the apparatus based on the first image and a feature map extracted from a convolution block for each stage of a lightweight target model for the first image.

The lightweight target model may include at least one first convolution block to generate the feature map, and the second generator may include at least one second convolution block to generate a feature enhancement map.

The feature map of the first convolution block mapped with the second convolution block may be combined with the feature enhancement map of the second convolution block.

The first convolution block mapped with the second convolution block may include a remaining first convolution block except the first convolution block of a last stage of the lightweight target model.

The third generator may generate a fourth image by applying a scaling parameter which adjusts an output channel distribution to the third image.

The scaling parameter may be learned such that a channel distribution value of the third image is close to a channel distribution value of original training data of the lightweight target model.

The first generator may iteratively generate the first image for a first sample vector a preset number of times, and upon the preset number of times being exceeded, iteratively generate the first image for a second sample vector after the first generator is initialized.

A method for generating training data according to an embodiment is performed by an apparatus for generating training data including at least one processor and a memory to store instructions for executing the at least one process, and the method includes outputting a first image for one sample vector from a first generator included in the apparatus; and generating a second image from a second generator included in the apparatus based on the first image and a feature map extracted from a convolution block for each stage of a lightweight target model for the first image.

The lightweight target model may include at least one first convolution block to generate the feature map, and the second generator may include at least one second convolution block to generate a feature enhancement map.

The feature map of the first convolution block mapped with the second convolution block may be combined with the feature enhancement map of the second convolution block.

The first convolution block mapped with the second convolution block may include a remaining first convolution block except the first convolution block of a last stage of the lightweight target model.

In case of the at least one second convolution block being a plurality of second convolution blocks, the feature enhancement map of a previous second convolution block in combination with the feature map of the first convolution block corresponding to the previous second convolution block may be included in an input value of a next second convolution block.

The feature map of the first convolution block of the last stage may be used as an input value of the second generator.

The method may further include generating a third image from a third generator included in the apparatus based on at least one of the first image or the second image.

The generating of the third image may include generating a fourth image by applying a scaling parameter which adjusts an output channel distribution to the third image.

The scaling parameter may be learned such that a channel distribution value of the third image is close to a channel distribution value of original training data of the lightweight target model.

The generating of the first image may include iteratively generating the first image for a first sample vector a preset number of times, and upon the preset number of times being exceeded, initializing the first generator and iteratively generating the first image for a second sample vector.

The disclosed embodiments may overcome the mode collapse of the image generator by re-initializing the first generator for each latent vector.

The disclosed embodiments may generate similar training data with enhanced features of original training data using the feature map of the lightweight target model.

The disclosed embodiments may generate similar training data with fidelity to the distribution of original training data by combining the feature map for each stage of the lightweight target model with the feature map of the second image in the reverse order.

The disclosed embodiments may achieve the optimization process and nonlinear optimization of each network by generating each one image of mini-batch.

The disclosed embodiments may generate similar training data reflecting the channel distribution of original training data by using the scaling parameter.

### BRIEF DESCRIPTION OF THE DRAWINGS

FIG. 1 is a block diagram illustrating an apparatus for generating training data according to an embodiment.

FIG. 2 is a diagram exemplarily illustrating a process of generating a second image.

FIG. 3 is a block diagram illustrating an apparatus for generating training data according to an embodiment.

FIG. 4 is a diagram showing an algorithm of an apparatus for generating training data according to an embodiment.

FIG. 5 is a comparison diagram for qualitatively comparing the performance of an apparatus for generating training data according to an embodiment.

FIG. 6 is a table showing the quantitative comparison results of knowledge distillation performance of an apparatus for generating training data according to an embodiment.

FIGS. 7A and 7B are graphs showing the quantitative comparison results of pruning performance of an apparatus for generating training data according to an embodiment.

FIG. 8 is a flowchart illustrating a method for generating training data according to an embodiment.

FIG. 9 is a flowchart illustrating a method for generating training data according to an embodiment.

### DETAILED DESCRIPTION

Hereinafter, embodiments will be described in detail with reference to the accompanying drawings. The following detailed description is provided to help a comprehensive understanding of a sensor described herein. However, this is provided by way of illustration and the present disclosure is not limited thereto.

In describing the embodiments, when it is determined that a certain detailed description of known technology related to the present disclosure may unnecessarily obscure the subject matter of an embodiment, the detailed description is omitted. Additionally, the number (for example, first, second or the like) used in the process of describing the embodiments is an identification sign for distinguishing one element from another.

The terms as used herein are defined in consideration of functions in the present disclosure, and may vary depending on the user or operator's intention or the convention. Therefore, the definition should be made based on the disclosure throughout the specification. The terms as used herein are used to describe the embodiments but not intended to limit them. Unless the context clearly indicates otherwise, the singular form as used herein includes the plural form. The term “comprising” or “including” when used in this specification, specifies the presence of stated components, integers, steps, operations, elements, some of them or a combination thereof, and should not be interpreted as precluding the presence or addition of one or more other components, integers, steps, operations, elements, some of them or a combination thereof.

Additionally, the embodiment described herein may have aspects of entirely hardware, partly hardware and partly software, or entirely software. The unit used herein refers to a computer related entity such as hardware, a combination of hardware and software, or software.

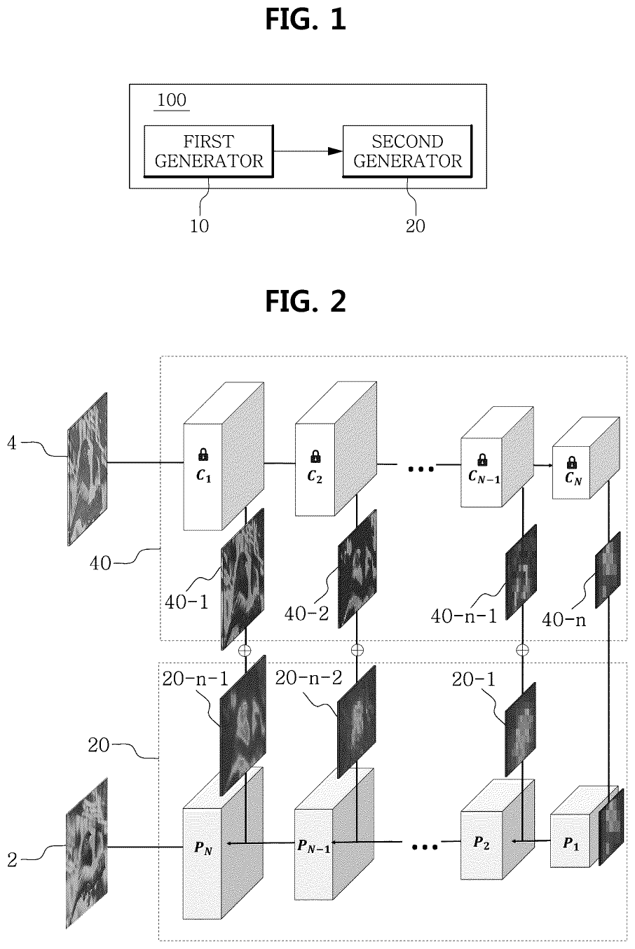

FIG. 1 is a block diagram illustrating an apparatus 100 for generating training data according to an embodiment.

Referring to FIG. 1, the apparatus 100 for generating training data according to an embodiment includes a first generator 10 and a second generator 20.

The first generator 10 and the second generator 20 may be executed or implemented using at least one processor included in the apparatus 100 for generating training data. However, the first generator 10 and the second generator 20 may not be clearly distinguished in detailed operation as opposed to the shown example.

The first generator 10 outputs a first image for one sample vector.

The first generator 10 may include an artificial neural network to generate an arbitrary image based on Generative Adversarial Networks (GAN).

Here, the sample vector may include a latent vector in a latent space sampled from arbitrary noise.

The sample vector may be sampled to be mapped to a data space of a distribution of original training data. Specifically, the sample vector may be a latent vector sampled in a normal distribution or uniform distribution based on a true value of original training data encoded with a one-hot vector.

An optimized weight corresponding to the sample vector may be applied to the first generator 10. In this instance, the first generator 10 may generate the first image by applying the optimized weight for one sample vector a preset number of times of training.

For example, the first generator 10 may iteratively generate different first images of a first mini-batch for a first latent vector the preset number of times. In this instance, the first generator 10 may update a first weight by iteratively generating the first image for the first latent vector each time.

Subsequently, when the preset number of times is exceeded, the first generator 10 may iteratively generate a second mini-batch of first images for a second latent vector a preset number of times. In this instance, the first generator 10 may update a second weight by iteratively generating the first image for the second latent vector each time.

Here, the second weight may be calculated in the process of optimizing the initialized first generator 10. In other words, after calculating the optimized weight for each latent vector, the first generator 10 may be initialized to apply the weight for the next latent vector. The first generator 10 may generate the first image by getting updated with the unique weight for each latent vector.

The second generator 20 may generate a second image based on a feature map of a convolution block for each stage for the first image of a lightweight target model 40.

The lightweight target model 40 refers to a model that is a target to be lightweight, and may be a trained classifier based on the original training data to be reproduced.

The lightweight target model 40 may include a Convolutional Neural Network (CNN) including at least one first convolution block to generate the feature map. The second generator 20 may include a CNN including at least one second convolution block to generate a feature enhancement map.

The second generator 20 may generate the second image based on the extracted feature map of the first convolution block when the first image is inputted to the lightweight target model 40.

The second generator 20 may generate the second image by incorporating the feature map extracted from each of at least one first convolution block into the feature enhancement map extracted from the second convolution block.

The second generator 20 may generate the second image by adding the feature map extracted from each of the at least one first convolution block to the feature enhancement map extracted from the second convolution block. Here, the feature enhancement map is intended to be added to the feature map element-wisely.

The “incorporate” as used herein may be interpreted as encompassing “add”, “include” and “connect”, and redundant descriptions are omitted for convenience of description.

The second convolution blocks may be connected in a sequential order so that the output value of the previous second convolution block may be included in the input value of the next second convolution block.

In other words, the previous feature enhancement map outputted from the second convolution block in combination with the feature map extracted from the first convolution block may be used as the input value of the next second convolution block.

The second generator 20 may generate the second image by incorporating the feature map outputted from the first convolution block mapped with the second convolution block into the feature enhancement map extracted from the second convolution block.

The second generator 20 may incorporate the feature map of the first convolution block mapped with the second convolution block and the feature enhancement map of the second convolution block into a feature combination map, and may use as the input value of the second convolution block.

The first convolution block may be mapped with the second convolution block of high to low stage in an order from low to high stage. Alternatively, as the stage is lower, the first convolution block may be mapped with the second convolution block of lower stage.

In this instance, the first convolution block mapped with the second convolution block may include the remaining first convolution block except the first convolution block of the last stage of the lightweight target model 40.

The second generator 20 may generate the second image by using, as input, the feature map extracted from the convolution block of the last stage among the first convolution blocks of the lightweight target model 40.

The second convolution block may include at least one of a convolution layer or an upsampling layer.

For example, the second convolution block may include at least one of a 1×1 convolution layer for global learning or a 3×3 convolution layer for a small amount of computational resources.

For example, the second convolution block of the first stage may include the 1×1 convolution layer. The second convolution block of each of the second to n^{th} stages may include the 3×3 convolution layer.

The second convolution block may upsample the size of at least one of the feature map, the feature enhancement map or the feature combination map being fed.

The second convolution block may upsample the size of the map being fed such that the size of at least one of the feature map, the feature enhancement map or the feature combination map being fed matches the input size of the second convolution block.

The second convolution block may output the feature enhancement map using the following [Equation 1].

$${p}_{l} = \{ \begin{matrix}{W}_{1}^{l} ( Φ ( {f}_{N} ) ) , & ( l = 1 ) \\ {W}_{1}^{l} ( Φ ( {W}_{3}^{l} ( {p}_{l - 1} ⊕ {f}_{N - l} ) ) , & ( l \neq 1 )\end{matrix} \qquad [ Equation 1 ]$$

Here, pᵢ may denote the lth feature enhancement map, W₁^{l} may denote the lth convolution layer having the filter size of 1×1, W₃^{l} may denote the lth convolution layer having the filter size of 3×3, Φ may denote the upsampling layer, f_{N} may denote the Nth feature map, and the operator ⊕ may denote the elementwise addition.

The second generator 20 may generate the second image for the same latent vector the preset number of times. The second generator 20 may iteratively generate the second image the preset number of times. When the preset number of times is exceeded, the second generator 20 may iteratively generate the second image for a second sample vector again the preset number of times.

In this instance, when the preset number of times is exceeded, the second generator 20 may be initialized for complete optimization for another sample vector.

FIG. 2 is a diagram illustrating the process of generating the second image 2 by the second generator 20.

Referring to FIG. 2, the lightweight target model 40 includes n first convolution blocks C₁, C₂, . . . Cₙ. The second generator 20 includes n second convolution blocks P₁, P₂, . . . Pₙ.

The first convolution blocks C₁, C₂, . . . Cₙ₋₁ of the first to n−1^{th} stages may be respectively mapped with the second convolution blocks P₁, P₂, . . . Pₙ₋₁ of the n−1^{th} to first stages in a sequential order. In this instance, the feature map 40-n of the first convolution block Cₙ of the nth stage may be used as the input value of the second generator 20.

That is, the first feature map 40-1 to the n−1^{th} feature map 40-n−1 may be respectively added to the n−1^{th} feature enhancement map 20-n−1 to the first feature enhancement map 20-1 and may be used for image generation of the second generator 20.

Specifically, the n^{th} feature map 40-n may be provided as the input value of the second generator 20, and the n−1^{th} feature map 40-n−1 may be added to the first feature enhancement map 20-1, and in the same way, the n−2th feature enhancement map 20-n−2 may be added to the second feature map 40-2, and the n−1^{th} feature enhancement map 20-n−1 may be added to the first feature map 40-1.

In this instance, at least one of the feature map, the feature enhancement map or the feature combination map may be upsampled according to the input size of the second convolution block.

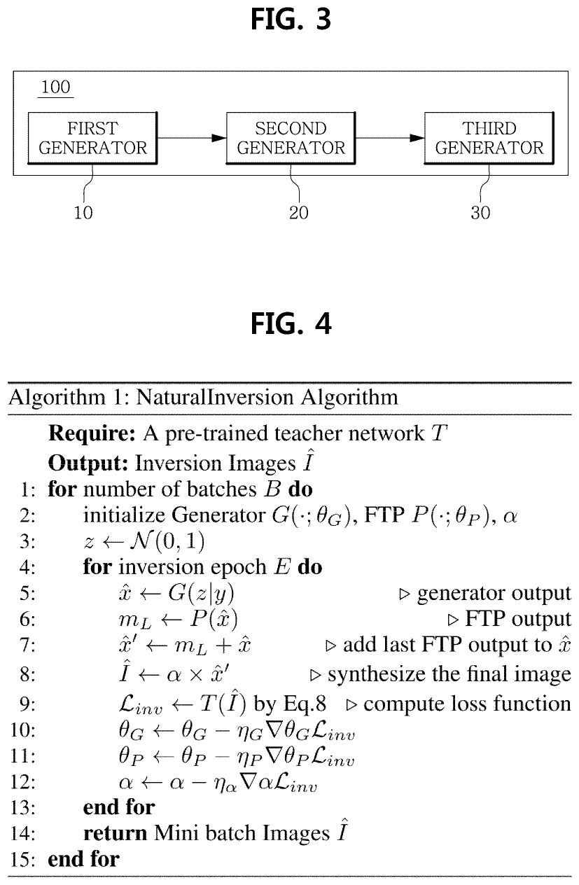

FIG. 3 is a block diagram illustrating the apparatus 100 for generating training data according to an embodiment.

Referring to FIG. 3, the apparatus 100 for generating training data according to an embodiment includes the first generator 10, the second generator 20 and a third generator 30.

The first generator 10, the second generator 20 and the third generator 30 may be executed or implemented using the at least one processor included in the apparatus 100 for generating training data, or as opposed to the shown example, the first generator 10, the second generator 20 and the third generator 30 may not be clearly distinguished in detailed operation.

Here, the first generator 10 and the second generator 20 are the same as those of FIG. 1, and redundant descriptions are omitted.

The third generator 30 generates a third image based on at least one of the first image or the second image. The third generator 30 may generate the third image by applying a scaling parameter that adjusts the output channel distribution to the second image.

Here, the scaling parameter may be a learned parameter such that the channel distribution value of the image to which the scaling parameter is applied is close to the channel distribution value of the original training data of the lightweight target model 40.

For example, the third generator 30 may generate the third image by applying a first scaling parameter to the second image. In this instance, the first scaling parameter may be a learned parameter such that the channel distribution value of the second image is close to the channel distribution value of the original training data of the lightweight target model 40.

The scaling parameter may be defined based on the following [Equation 2].

$$αϵ {R}^{BXCX 1 X 1} \qquad [ Equation 2 ]$$

Here, α may denote the scaling parameter, B may denote the batch size, and C may denote the number of channels.

The third generator 30 may generate the third image by adding the first image to the second image to prevent the feature loss of the first image. Specifically, the third generator 30 may generate the third image based on the sum of the first image and the second image per pixel.

The third generator 30 may generate a fourth image by applying the scaling parameter that adjusts the output channel distribution to the third image.

For example, the third generator 30 may generate the fourth image by applying a second scaling parameter to the third image. Here, the second scaling parameter may be a learned parameter such that the channel distribution value of the third image is close to the channel distribution value of the original training data of the lightweight target model 40.

The third generator 30 may generate the fourth image based on the following [Equation 3].

$${\hat{I}}_{i} = {a}_{i} ⊗ ( {m}_{L} ⊕ G ( z \vert y ) ) \qquad [ Equation 3 ]$$

Here, Îᵢ may denote the fourth image, aᵢ may denote the scaling parameter, m_{L} may denote the second image, and G(z|y) may denote the first image. Here, the operator ⊕ may denote the elementwise addition, and ⊗ may denote the elementwise multiplication.

The fourth image may be inputted to the lightweight target model 40 again to calculate a gradient for optimization of each network (i.e., the first generator 10, the second generator 20 and the third generator 30).

The scaling parameters of the first generator 10, the second generator 20 and the third generator 30 may be optimized by the same objective function.

The objective function may be defined based on the following [Equation 4].

$${L}_{inv} ( \hat{I} , y ) = {L}_{CE} ( \hat{I} , y ) + {R}_{BN} ( \hat{I} ) + {R}_{prior} ( \hat{I} ) \qquad [ Equation 4 ]$$

In this instance, Lᵢₙᵥ(Î, y) may be the objective function of each network, Î may be the fourth image, y may be the true value of each network, L_{CE}(Î, y) may be an inception loss, R_{BN}(Î) may be a first regularizer, and Rₚᵣᵢₒᵣ(Î) may be a second regularizer.

The inception loss may be defined based on the following [Equation 5].

$${L}_{CE} ( \hat{I} , y ) = - {\sum }_{i} {\hat{y}}_{i} log {y}_{i} \qquad [ Equation 5 ]$$

Here, ŷᵢ may denote the i^{th} predicted value, and yᵢ may denote the i^{th} true value. The first regularizer may refer to a function for network optimization such that the generated training data matches the distribution of original training data.

Specifically, the first regularizer may be defined based on the following [Equation 6].

$${R}_{BN} = {\sum }_{i = 1}^{l} ( {‖ {μ}_{i} ( \hat{x} ) - {\hat{μ}}_{i} ‖}^{2} + {‖ {{σ}_{i}}^{2} ( \hat{x} ) - {{\hat{σ}}_{i}}^{2} ‖}^{2} \qquad [ Equation 6 ]$$

Here, \hat{μ}ᵢ may denote a running mean of the network, \hat{σ}ᵢ² may denote a running variance of the network, and μᵢ(\hat{x}) and σᵢ²(\hat{x}) may denote the mean and variance of the feature map outputted from the i^{th} layer of each network, respectively.

The second regularizer may be a function for optimization of each network to stably generate the generated training data.

The second regularizer may be defined based on the following [Equation 7].

$${R}_{prior} = {λ}_{TV} {R}_{TV} ( \hat{x} ) + {λ}_{{l}_{2}} {R}_{{l}_{2}} ( \hat{x} ) \qquad [ Equation 7 ]$$

Rₚᵣᵢₒᵣ may denote the second regularizer, R_{TV}(\hat{x}) may denote a denoising function for the image \hat{x}, λ_{TV} may denote a first scaling factor, l₂ may denote normalization, Rₗ_{₂}(\hat{x}) may denote a sparsity penalty function for the image \hat{x}, and λₗ_{₂}, may denote a second scaling factor.

FIG. 4 is a diagram showing the algorithm of the apparatus 100 for generating training data according to an embodiment.

Referring to FIG. 4, the apparatus 100 for generating training data according to an embodiment outputs a mini-batch targeted towards a pre-trained teacher model T.

In this instance, the apparatus 100 for generating training data according to an embodiment outputs the image Î of the mini-batch using the first generator 10 (G(z|y)), the second generator 20 (P(\hat{x})) and the scaling parameter α.

First, the first generator 10 (G(z|y)), the second generator 20 and the scaling parameter α may be initialized for optimization for each sample vector.

Subsequently, the first generator 10 (G(z|y)) receives the input of the sample vector z for a preset number of epochs and output the first image \hat{x}.

Subsequently, the second generator 20 (P(\hat{x})) may input the first image \hat{x} for the preset number of epochs and output the second image m_{L}.

Subsequently, the third generator 30 may generate the third image [symbol] by summing the first image \hat{x} and the second image m_{L} for the preset number of epochs.

Subsequently, the third generator 30 may generate the fourth image Î by multiplying the third image [symbol] by the scaling parameter α for the preset number of epochs.

Here, each network (i.e., the first generator 10, the second generator 20 and the third generator 30) may be optimized based on the objective function.

Specifically, the weight for the first generator 10 may be updated based on the following [Equation 8].

$${θ}_{G} = {θ}_{G} - {n}_{G} ∇ {θ}_{G} {L}_{inv} \qquad [ Equation 8 ]$$

In this instance, θ_{G} may be the weight applied to the first generator 10 for each sample vector, n_{G} may be a learning rate of the first generator 10, and Lᵢₙᵥ may be the objective function.

Specifically, the weight for the second generator 20 may be updated based on the following [Equation 9].

$${θ}_{P} = {θ}_{P} - {n}_{P} ∇ {θ}_{P} {L}_{inv} \qquad [ Equation 9 ]$$

In this instance, θ_{P} may be the weight applied to the second generator 20 for each sample vector, nₚ may be a learning rate of the second generator 20, and Lᵢₙᵥ may be the objective function.

Specifically, the scaling parameter may be updated based on the following [Equation 10].

$$α = α - {n}_{α} ∇ α {L}_{inv} \qquad [ Equation 10 ]$$

In this instance, α may be the scaling parameter, n_{α} may be a learning rate of the scaling parameter, and Lᵢₙᵥ may be the objective function.

The first generator 10, the second generator 20 and the third generator 30 may iteratively generate each of the first image, the second image, the third image and the fourth image for one sample vector for the preset number of epochs. When the preset number of epochs is exceeded, at least one of the first generator 10, the second generator 20 or the third generator 30 may be re-initialized.

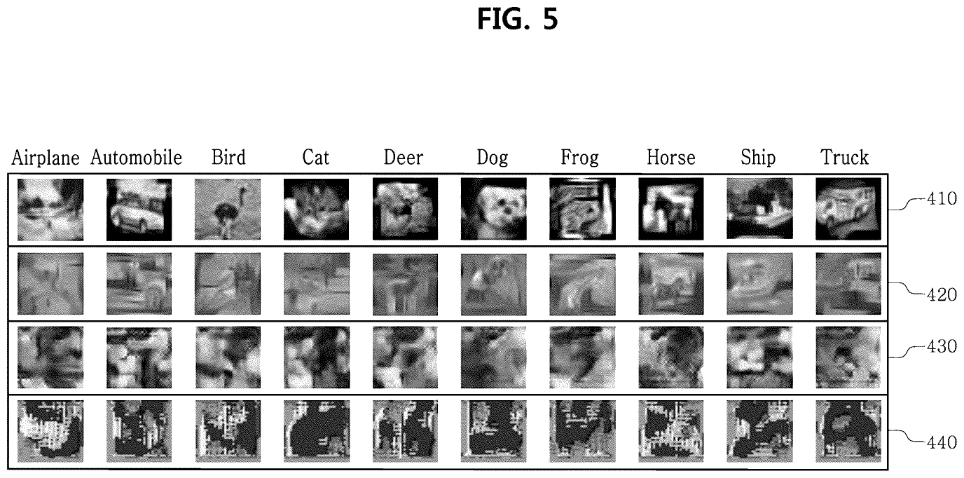

FIG. 5 is a comparison diagram for qualitatively comparing the performance of the apparatus 100 for generating training data according to an embodiment.

Referring to FIG. 5, training data generated using the apparatus 100 for generating training data according to an embodiment or the known technology is shown. In this instance, the lightweight target model 40 is ResNet-34, and the original training data is CIFAR-10 dataset.

A first dataset 410 is a final image set outputted from the apparatus 100 for generating training data according to an embodiment. It is found that airplane, automobile, bird, cat, deer, dog, frog, horse, ship and truck images generated by the apparatus 100 for generating training data according to an embodiment are identifiable.

A second dataset 420 is a final image set generated using Deep Inversion (DI). It is found that airplane, automobile, bird, cat, deer, dog, frog, horse, ship and truck images generated by DI are not identifiable.

A third dataset 430 is a final image set generated using Data-Free Adversarial Distillation (DFAD). It is found that airplane, automobile, bird, cat, deer, dog, frog, horse, ship and truck images generated by DFAD are not identifiable.

A fourth dataset 440 is a final image set generated using Data-Free Learning (DAFL). It is found that airplane, automobile, bird, cat, deer, dog, frog, horse, ship and truck images generated by DAFL are not identifiable.

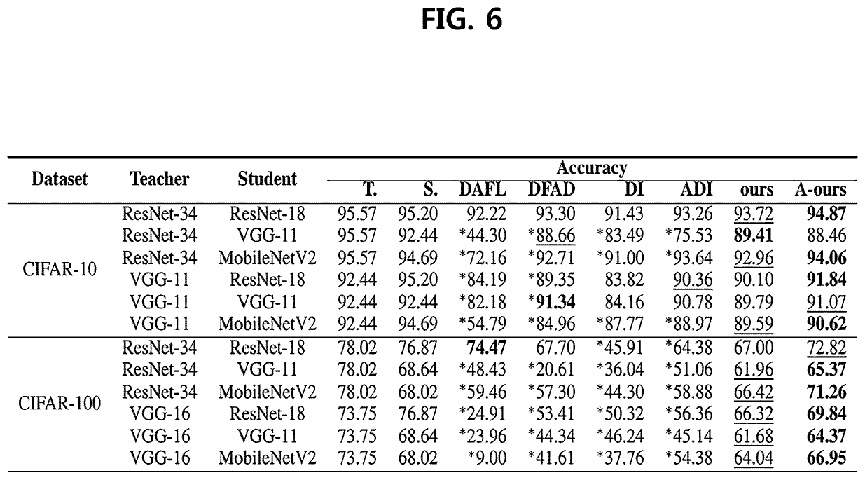

FIG. 6 is a table showing the quantitative comparison results of performance of the apparatus 100 for generating training data according to an embodiment.

Referring to FIG. 6, the results of knowledge distillation of the apparatus 100 for generating training data according to an embodiment and the known technology are shown. In this instance, the original training data may be original training data CIFAR-10 or CIFAR-100.

Referring to FIG. 6, any network of the teacher model and the student model achieves higher accuracy than knowledge distillation using DAFL, DFAD, DI or ADI.

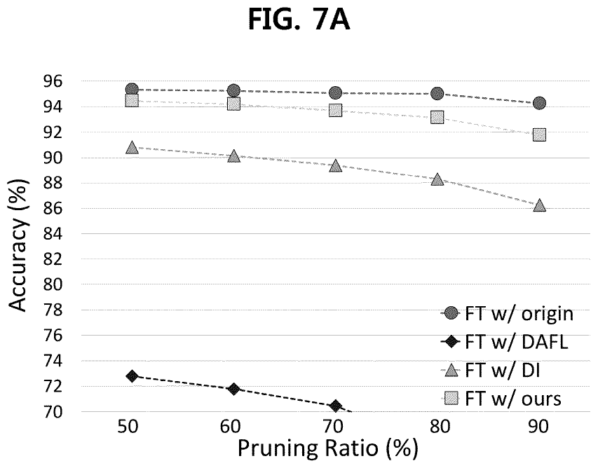

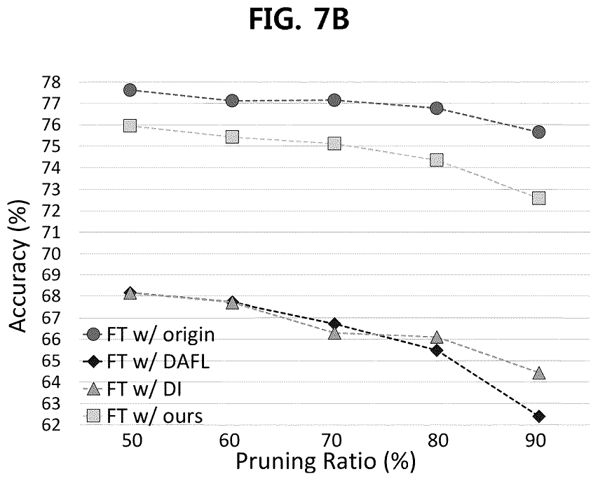

FIG. 7A is a graph showing the quantitative comparison results of fine-tuning after pruning using the apparatus 100 for generating training data according to an embodiment.

FIG. 7A shows the pruning results of the apparatus 100 for generating training data according to an embodiment and the known technology. In this instance, the lightweight target model 40 may be ResNet-34 trained with image classification based on CIFAR-10.

As shown in FIG. 7A, it is found that the training data according to an embodiment achieves higher accuracy than lightweight deep learning using DAFL or DI even at varying pruning ratios.

FIG. 7B is a graph showing the quantitative comparison results of performance of the apparatus 100 for generating training data according to an embodiment.

FIG. 7B shows the pruning results of the apparatus 100 for generating training data according to an embodiment and the known technology. In this instance, the lightweight target model 40 may be ResNet-34 trained with image classification based on CIFAR-100.

As shown in FIG. 7B, it is found that the training data according to an embodiment achieves higher accuracy than lightweight deep learning using DAFL or DI even at varying pruning ratios.

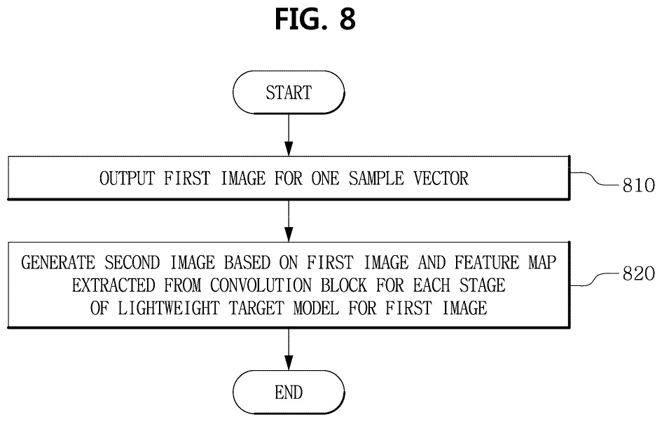

FIG. 8 is a flowchart illustrating a method for generating training data according to an embodiment.

Referring to FIG. 8, the method for generating training data according to an embodiment may be performed by the apparatus 100 for generating training data as shown in FIG. 1.

To begin with, the apparatus 100 for generating training data according to an embodiment outputs the first image for one sample vector (810).

Subsequently, the apparatus 100 for generating training data according to an embodiment generates the second image based on the first image and the feature map of the convolution block for each stage of the lightweight target model 40 for the first image (820).

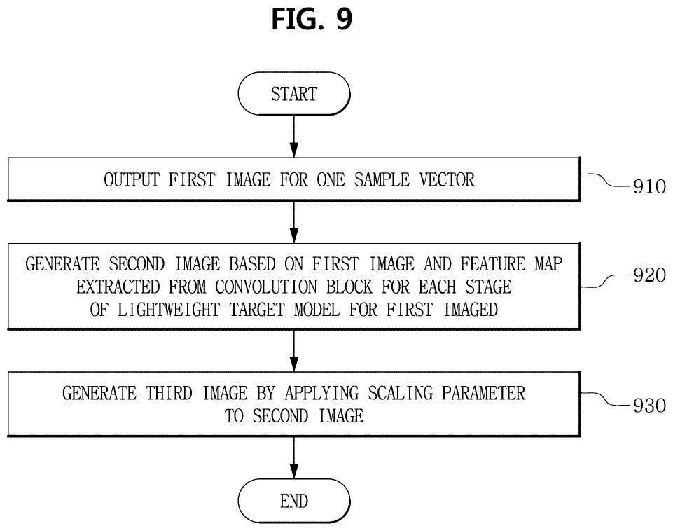

FIG. 9 is a flowchart illustrating the method for generating training data according to an embodiment.

Referring to FIG. 9, the method for generating training data according to an embodiment may be performed by the apparatus 100 for generating training data as shown in FIG. 3.

To begin with, the apparatus 100 for generating training data according to an embodiment outputs the first image for one sample vector (910).

Subsequently, the apparatus 100 for generating training data according to an embodiment generates the second image based on the first image and the feature map of the convolution block for each stage of the lightweight target model 40 for the first image (920).

Subsequently, the apparatus 100 for generating training data according to an embodiment generates the third image by applying the scaling parameter to the second image (930).

FIGS. 8 and 9 have been described with reference to the sequence shown in the drawings. Although the method has been illustrated and described by a series of blocks for description, the present disclosure is not limited to the sequence of the blocks, and some of the blocks may be set up in different sequences from the sequence shown and described herein, or some and the others may be set up at the same time, and a variety of other branches, flow paths and sequences of blocks that achieve the identical or similar results may be realized. Additionally, all the blocks may not be required to perform the method described herein.

Meanwhile, the embodiment of the present disclosure may include programs for performing the methods described herein on the computer, and computer readable recording media including the programs. The computer readable recording medium may include program instructions, local data files and local data structures, singly or in combination. The medium may be those specially designed and configured for the present disclosure or commonly used in the field of computer software. Examples of the computer readable recording medium include hardware devices specially designed to store and execute the program instructions, for example, magnetic media such as hard disk, floppy disk and magnetic tape, optical media such as CD-ROM and DVD, and ROM, RAM and flash memory. Examples of the program may include machine code generated by a compiler as well as high-level language code that can be executed by the computer using an interpreter.

While the representative embodiments of the present disclosure have been hereinabove described in detail, those skilled in the art will understand that a variety of modifications may be made to the above-described embodiment without departing from the scope of the present disclosure. Therefore, the scope of protection of the present disclosure should not be limited to the disclosed embodiment, and should be defined by the appended claims and their equivalents.

### DETAILED DESCRIPTION OF MAIN ELEMENTS

2: Second image
4: First image
10: First generator
20: Second generator
20-1: First feature enhancement map
20-n−1: n−1^{th} feature enhancement map
20-n−2: n−2^{th} feature enhancement map
30: Third generator
40: Lightweight target model
40-1: First feature map
40-2: Second feature map
40-n−1: n−1^{th} feature map
40-n: n^{th} feature map
100: Apparatus for generating training data
410: First dataset
420: Second dataset
430: Third dataset
440: Fourth dataset

What is claimed is:

1. An apparatus for generating training data, comprising:
at least one processor; and
a memory to store instructions for executing the at least one processor,
wherein upon being executed by the at least one processor, the instructions allow the at least one processor to:
output a first image for one sample vector from a first generator included in the apparatus, and
generate a second image from a second generator included in the apparatus based on the first image and a feature map extracted from a convolution block for each stage of a lightweight target model for the first image.

2. The apparatus for generating training data according to claim 1, wherein the lightweight target model includes at least one first convolution block to generate the feature map, and
wherein the second generator includes at least one second convolution block to generate a feature enhancement map.

3. The apparatus for generating training data according to claim 2, wherein the feature map of the first convolution block mapped with the second convolution block is combined with the feature enhancement map of the second convolution block.

4. The apparatus for generating training data according to claim 3, wherein the first convolution block mapped with the second convolution block includes a remaining first convolution block except the first convolution block of a last stage of the lightweight target model.

5. The apparatus for generating training data according to claim 3, wherein in case of the at least one second convolution block being a plurality of second convolution blocks, the feature enhancement map of a previous second convolution block in combination with the feature map of the first convolution block corresponding to the previous second convolution block is included in an input value of a next second convolution block.

6. The apparatus for generating training data according to claim 4, wherein the feature map of the first convolution block of the last stage is used as an input value of the second generator.

7. The apparatus for generating training data according to claim 1, wherein upon being executed by the at least one processor, the instructions allow the at least one processor to generate a third image from a third generator included in the apparatus based on at least one of the first image or the second image.

8. The apparatus for generating training data according to claim 7, wherein the third generator generates a fourth image by applying a scaling parameter which adjusts an output channel distribution to the third image.

9. The apparatus for generating training data according to claim 8, wherein the scaling parameter is learned such that a channel distribution value of the third image is close to a channel distribution value of original training data of the lightweight target model.

10. The apparatus for generating training data according to claim 1, wherein the first generator iteratively generates the first image for a first sample vector a preset number of times, and upon the preset number of times being exceeded, iteratively generates the first image for a second sample vector after the first generator is initialized.

11. A method for generating training data, performed by an apparatus for generating training data, including at least one processor and a memory to store instructions for executing the at least one process, the method comprising:
outputting a first image for one sample vector from a first generator included in the apparatus; and
generating a second image from a second generator included in the apparatus based on the first image and a feature map extracted from a convolution block for each stage of a lightweight target model for the first image.

12. The method for generating training data according to claim 11, wherein the lightweight target model includes at least one first convolution block to generate the feature map, and
wherein the second generator includes at least one second convolution block to generate a feature enhancement map.

13. The method for generating training data according to claim 12, wherein the feature map of the first convolution block mapped with the second convolution block is combined with the feature enhancement map of the second convolution block.

14. The method for generating training data according to claim 13, wherein the first convolution block mapped with the second convolution block includes a remaining first convolution block except the first convolution block of a last stage of the lightweight target model.

15. The method for generating training data according to claim 13, wherein in case of the at least one second convolution block being a plurality of second convolution blocks, the feature enhancement map of a previous second convolution block in combination with the feature map of the first convolution block corresponding to the previous second convolution block is included in an input value of a next second convolution block.

16. The method for generating training data according to claim 14, wherein the feature map of the first convolution block of the last stage is used as an input value of the second generator.

17. The method for generating training data according to claim 11, further comprising:
generating a third image from a third generator included in the apparatus based on at least one of the first image or the second image.

18. The method for generating training data according to claim 17, wherein the generating of the third image comprises generating a fourth image by applying a scaling parameter which adjusts an output channel distribution to the third image.

19. The method for generating training data according to claim 18, wherein the scaling parameter is learned such that a channel distribution value of the third image is close to a channel distribution value of original training data of the lightweight target model.

20. The method for generating training data according to claim 11, wherein the generating of the first image comprises iteratively generating the first image for a first sample vector a preset number of times, and upon the preset number of times being exceeded, initializing the first generator and iteratively generating the first image for a second sample vector.
